(19) United States
(12) Patent Application Publication
(10) Pub. No.: US 2013/0333125 A1
(43) Pub. Date: Dec. 19, 2013

(54) INSTRUMENT CLEANING ASSEMBLY AND APPARATUS

(71) Applicant: Ali Waqar Majeed, Sheffield (GB)

(72) Inventor: Ali Waqar Majeed, Sheffield (GB)

(21) Appl. No.: 13/980,369

(22) PCT Filed: Jan. 17, 2012
(86) PCT No.: PCT/GB12/50092

§ 371 Date: Sep. 4, 2013

(30) Foreign Application Priority Data
Feb. 3, 2011 (GB) 1101872.8

(51) Int. Cl. B08B 1/00

(52) U.S. Cl. CPC B08B 1/002
USPC 15/21.1

(57) ABSTRACT

An instrument cleaning assembly (14) comprises a cleaning device (16) and a guide arrangement (18) upon which the cleaning device is mounted. The cleaning device is movable relative to the guide arrangement, and the guide arrangement guides the cleaning device to clean an instrument (12) during the aforesaid movement. An instrument cleaning apparatus (10) comprises an instrument cleaning zone in which the instrument to be cleaned can be disposed, and at least one instrument cleaning assembly (14) disposed adjacent to the instrument cleaning zone.

This invention relates to instrument cleaning assemblies. This invention also relates to instrument cleaning apparatus. Embodiments of the invention relate to instrument cleaning apparatus which incorporate one or more instrument cleaning assemblies. Embodiments of the invention relate to cleaning assemblies and cleaning apparatus for cleaning medical instruments, such as endoscopes.

After use of an endoscope, it is passed to an operative who is required to clean it. Such cleaning generally involves washing the endoscope using hand held brushes and a supply of clean water. This can be extremely time consuming and unhygienic.

According to one aspect of this invention, there is provided an instrument cleaning assembly comprising a cleaning device and a guide arrangement upon which the cleaning device is mounted, wherein the cleaning device is movable relative to the guide arrangement, and the guide arrangement guides the cleaning device to clean an instrument during the aforesaid movement.

The instrument may be a surgical or medical instrument, such as an endoscope. Thus, the instrument cleaning assembly may be in the form of a surgical or medical instrument cleaner. The instrument cleaning assembly may be in the form of an endoscope cleaner.

The guide arrangement may comprise a guide member, which may be elongate. The guide arrangement may include a carriage mounted on the guide member for movement therealong. The guide arrangement may include a driver for driving the carriage along the guide member. The driver may be an electric, mechanical, pneumatic or hydraulic driver.

Where the driver comprises a pneumatic or hydraulic driver, the guide member may define an elongate chamber, and the driver may comprise a piston disposed in the chamber for movement therealong. The carriage may be attached to the piston. The chamber may have an elongate opening which may extend substantially the length of the chamber. The guide member may have fluid connection means to connect the chamber in fluid communication with a supply of pneumatic or hydraulic fluid. The guide member may have fluid connection means at least at one end thereof, and desirably the guide member has fluid connection means at each end thereof.

Sealing means may be provided along the opening to prevent leakage of fluid therefrom. The sealing means may comprise an elongate sealing member extending along the opening. The sealing means may comprise inner and outer elongate sealing members extending along the opening. The sealing means may be resiliently deformable to accommodate movement of the piston along the chamber.

Alternatively, the driver may comprise a mechanical driver. The guide arrangement may comprise a rack and pinion arrangement. The guide member may comprise a rack. A pinion may be rotatably mounted on the carriage. The driver may be operable to rotate the pinion to move the carriage along the rack.

Alternatively, the driver may comprise a motor, such as an electric motor.

The cleaning device may comprise a brush, which may be a rotary brush. The cleaning device may further include a connector to connect the brush to the carriage. The brush may be rotatably mounted on the connector. The connector may be pivotally mounted on the carriage for pivotal movement relative thereto.

In one embodiment, the connector may comprise two connecting members arranged opposite each other. The brush may extend from the one of the connecting members to the other connecting member.

The connector may include a bracing member, which may extend from one of the connecting members to the other connecting member. The connector may include two bracing members, each of which may extend from one of the connecting members to the other connecting member.

The connector may have a proximal end region and a distal end region. The brush may be mounted on the connector at the distal end region. The proximal end region of the connector may be pivotally mounted on the carriage.

In another embodiment, the connector may comprise a pair of first connecting means, which may be mounted on the carriage, and a pair of second connecting means, which may be movably attached to the first connecting means. Desirably, the second connecting means are pivotally attached to the first connecting means. In this second embodiment, the connector may comprise a pair of third connecting means, which may be movably attached to the second connecting means. Desirably, the third connecting means are pivotally attached to the second connecting means.

Alternatively, the second connecting means may be telescopically mounted on the first connecting means, whereby the second connecting means can slide relative to the first connecting means. The third connecting means may be telescopically mounted on the second connecting means, whereby the third connecting means can slide relative to the second connecting means.

In the first alternative, each of the first, second and third connecting means may comprise a plurality of telescopically mounted connecting elements.

According to another aspect of this invention, there is provided an instrument cleaning apparatus comprising an instrument cleaning zone in which an instrument to be cleaned can be disposed, and at least one instrument cleaning assembly as described above disposed adjacent to the instrument cleaning zone.

The instrument cleaning apparatus may comprise an instrument support.

According to another aspect of this invention, there is provided an instrument cleaning apparatus comprising an instrument support to support an instrument to be cleaned, and at least one instrument cleaning assembly as described above disposed adjacent to the instrument support.

The instrument support may be elongate, having a longitudinal axis. The instrument support may comprise an elongate support member.

The instrument support may be rotatable about the longitudinal axis, thereby rotating the instrument relative to the cleaning assembly.

The cleaning apparatus may comprise an urging assembly to urge the instrument support rotatably about the longitudinal axis.

The urging assembly may comprise a rotor on the instrument support. An urging device may be provided to engage the rotor and urge the rotor rotatably, thereby rotating the instrument support.

The rotor may comprise a ratchet member having a plurality of teeth, which may be provided around the circumference of the ratchet member. The urging device may comprise a pawl engageable with the ratchet member to impart said rotary motion thereto. The pawl may be engageable with the teeth to impart the aforesaid motion. In one embodiment, the pawl may be engageable with said teeth sequentially to impart the aforesaid motion.

The urging device may be pneumatically or hydraulically operated, and may include a chamber in which the pawl is reciprocally mounted. The chamber may receive said pneumatic or hydraulic fluid to move said pawl into engagement with said ratchet member.

In one embodiment, the urging arrangement may comprise two of said urging devices as described above, each urging device being operable on the ratchet member.

The instrument support may comprise a plurality of holding members to hold the instrument on the support.

The instrument cleaning apparatus may comprise a water supply arrangement for supplying water to the, or each, instrument cleaning assembly. The water supply arrangement may comprise a water dispenser and a conduit for connection to a supply of water. The water dispenser may comprise a shower head for spraying water onto the, or each, instrument cleaning assembly.

The water supply arrangement may comprise drive means to rotate the water dispenser.

The water supply arrangement may include a discharge means to discharge effluent from the instrument cleaning apparatus.

The instrument cleaning apparatus may comprise a housing within which the instrument support is provided. The, or each, instrument cleaning assembly may be provided within the housing.

The housing may comprise a lid to allow the instrument to be disposed in the instrument receiving zone. The water supply arrangement may be provided on the lid of the housing.

An embodiment of the invention will now be described by way of example only, with reference to the accompanying drawings, in which:

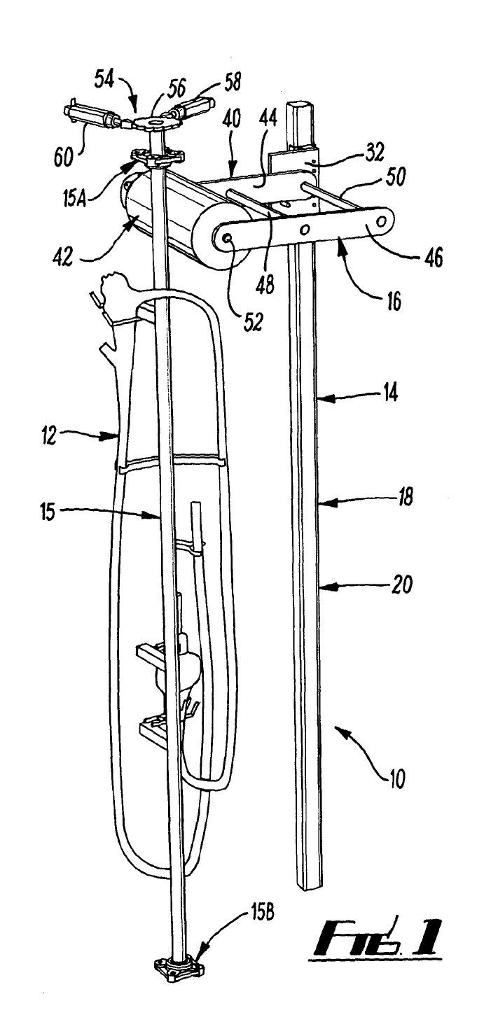

FIG. 1 is a perspective view of a cleaning apparatus, showing an instrument to be cleaned;

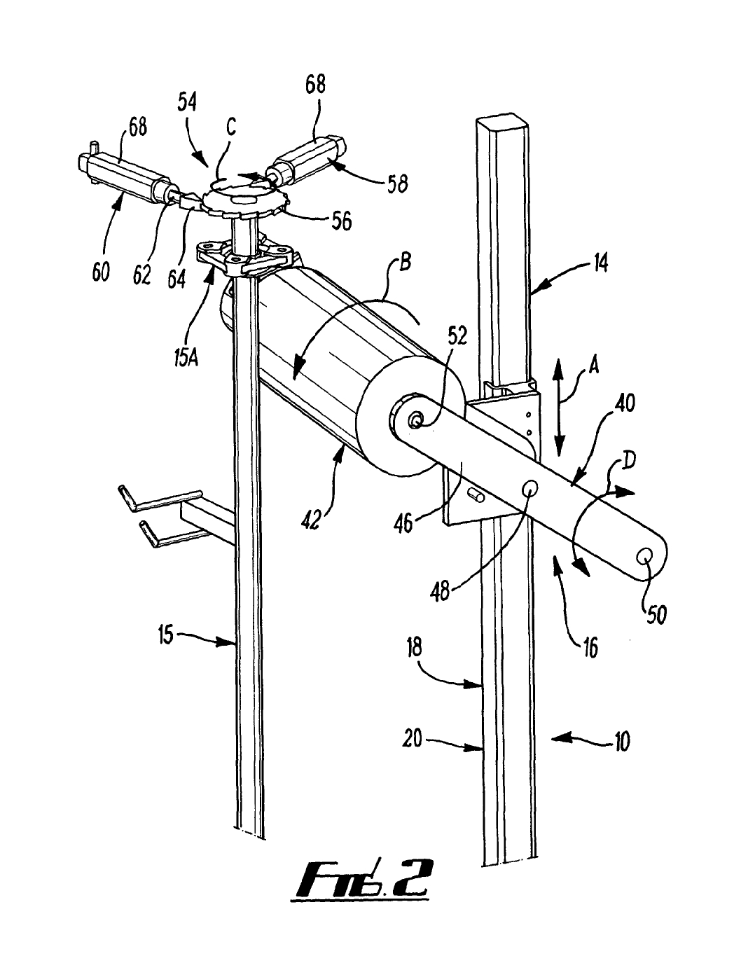

FIG. 2 is a close up view of an upper region of the cleaning apparatus;

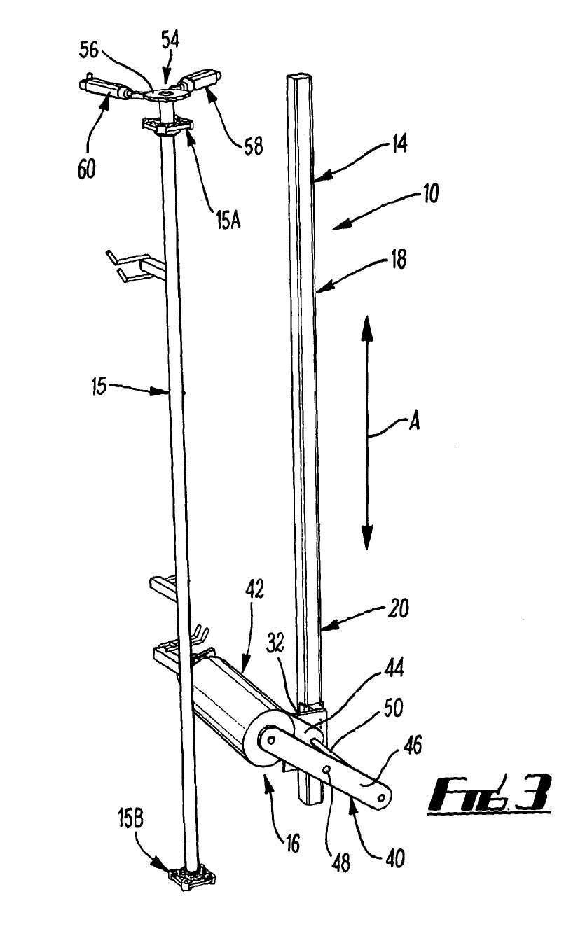

FIG. 3 is a perspective view of the cleaning apparatus, but with the instrument omitted;

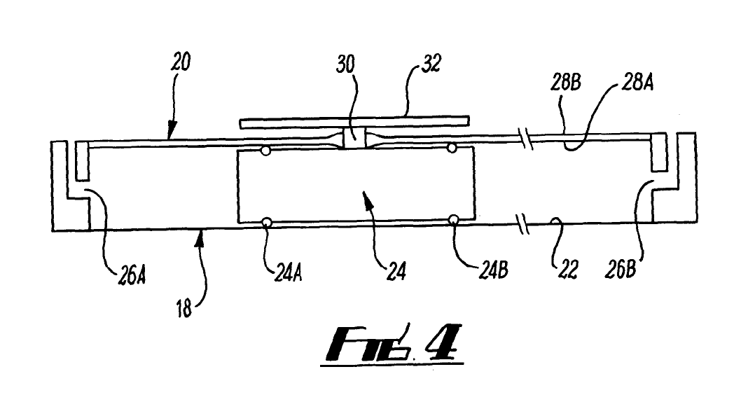

FIG. 4 is a diagrammatic cross sectional view of a guide arrangement;

FIG. 5 shows a cleaning apparatus having a housing;

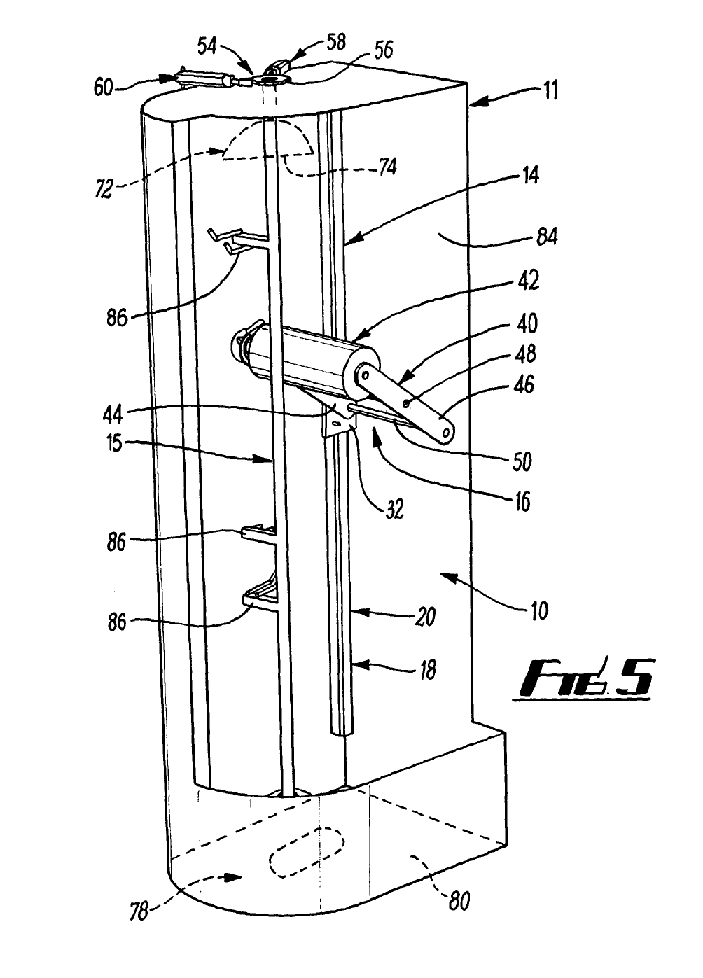

FIG. 6A shows an urging arrangement in one position;

FIG. 6B shows the urging arrangement in another position.

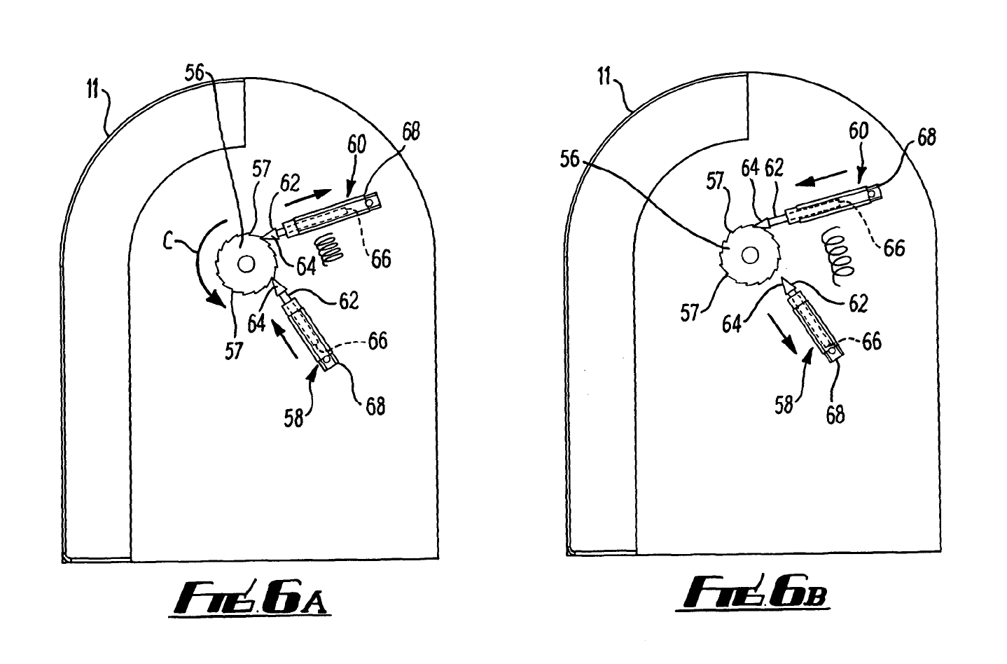

FIG. 7 is a side view of a first alternative version of the connector; and

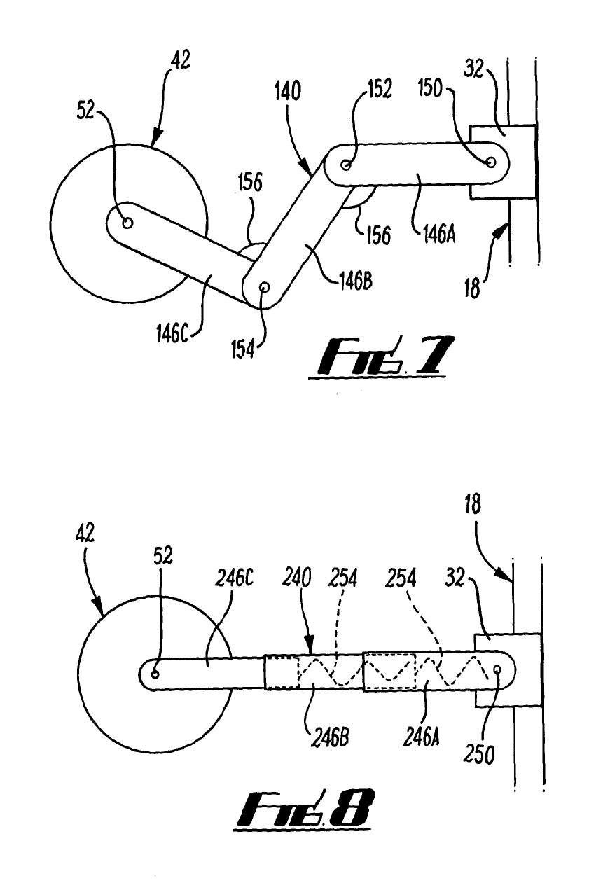

FIG. 8 is a side view of a second alternative version of the connector.

The drawings show an instrument cleaning apparatus 10 for cleaning an instrument, such as a surgical or medical instrument.

In the embodiment described herein, the surgical or medical instrument is in the form of an endoscope 12, but it will be appreciated that the cleaning apparatus can be used to clean other medical instruments.

The instrument cleaning apparatus 10 comprises an instrument cleaning assembly 14 and an elongate instrument support 15. The cleaning assembly 14 and the instrument support 15 are housed in a housing 11 (see FIG. 5).

The instrument support 15 is provided within a cleaning zone, the cleaning zone being located adjacent the instrument cleaning assembly 14. Thus, the instrument support 15 is located adjacent the instrument cleaning assembly 14. The cleaning zone may be substantially centrally located within the housing 11.

Upper and lower bearings 15A, 15B mount the instrument support 15 to the housing 11, and allow the instrument support 15 to rotate about its longitudinal axis, as described below.

The instrument cleaning assembly 14 comprises a cleaning device 16 and a guide arrangement 18.

In the embodiment shown, the guide arrangement 18 is in the form of a pneumatic guide arrangement, known as a rodless cylinder. The guide arrangement 18 is shown in FIG. 5, and comprises an elongate guide member 20 defining an elongate chamber 22.

A piston 24 is mounted within the chamber for reciprocal motion therealong. The piston 24 has seals 24A, 24B at opposite end regions which seal against the inside of the wall of the chamber 22 to prevent leakage of air therefrom.

The guide member 20 includes two air inlets 26A, 26B at the opposite upper and lower ends of the guide member 20. The purpose of the air inlets 26A, 26B is to allow air to be injected into the chamber 22 and discharged therefrom, depending upon the direction of movement of the piston 24.

The chamber 22 has an elongate inner sealing member, in the form of an inner sealing strip 28A, and an outer sealing member in the form of an outer sealing strip 28B. A link 30 extends from the piston 24 deforming the inner and outer sealing strips 28A, 28B outwardly. The link 30 extends to a carriage 32 arranged externally of the chamber 22, and spaced from the guide member 20.

In operation, if it is desired to move the piston 24 downwardly, as shown in FIG. 5, compressed air is introduced into the chamber 24 via the upper air inlet 26A. The seal 24A prevents air from leaking around the piston 24, and so the piston 24 is urged down the chamber 22.

During the movement of the piston 24, the link 30 continuously deforms the inner and outer sealing strips 28A, 28B, such that the deformation of the sealing strips 28A, 28B moves with the link 30. The seal 24A remains sealed against the wall of the chamber and against the inner sealing strip 28A, no air leaks from the chamber. Air which is below the piston 24 during its movement is discharged from the lower air inlet 26B

In order to move the piston upwardly, compressed air is introduced into the chamber via the lower air inlet 26B, and the process described above occurs, with the seal 24B preventing leakage of air around the piston 24, and air above the piston 24 is discharged via the upper air inlet 26A.

The cleaning device 16 is connected to the carriage 32. The cleaning device 16 comprises a connector 40 having a proximal end region attached to the carriage, 32 and a distal end region at which a rotary brush 42 is mounted. The connector 40 is pivotally mounted on the carriage 32, to allow the cleaning device 16 to pivot during cleaning.

The connector 40 includes two opposed connecting members 46 attached to each other by two bracing members 48, 50. The connecting members 46 are pivotally connected to the carriage 32 by the bracing member 50.

The brush 42 has a shaft 52 that is rotatably mounted at its opposite ends to the connecting members 46.

The cleaning device 16 is moved down the guide member 20 and back up again, as indicated by the double headed arrow A in FIGS. 2 and 3, by the movement of the piston 24, and thereby the carriage 32, as described above. This movement allows the brush 42 to engage the endoscope 12, as shown in FIG. 2 to clean it along the whole length of the endoscope 12.

The engagement of the brush 42 with the endoscope 12 causes the brush 42 to rotate, as indicated by the arrow B in FIG. 2, as it moves along the endoscope 12. In FIG. 3, the cleaning device 16 is shown at the lower end of the guide member 20 just before the direction of movement of the piston 24 is reversed.

The ability of the connector 40 to pivot allows the brush 42 to maintain a constant pressure on the endoscope 12 along the whole of its length, and to accommodate the position of the various features of the endoscope 12.

When the cleaning device 16 is returned to the top of the guide member 20, the instrument support 15 is rotated about its longitudinal axis by a few degrees and the process described above is carried out again. This is repeated several times until the instrument support 15 has rotated by 360° so that the whole endoscope 12 is thoroughly cleaned.

In order to rotate the instrument support 15, an urging assembly 54 is provided, and is shown in detail in FIGS. 6A and 6B.

The urging assembly 54 comprises a rotor in the form of a ratchet wheel 56 having a plurality of teeth 57 extending around the circumference thereof. The ratchet wheel 56 is mounted at its centre on the top of the instrument support 15, and extends radially therefrom.

The urging assembly 54 further includes two urging devices 58, 60 to engage the ratchet wheel 56 and urge it rotatably. Each urging device 58, 60 comprises a pawl 62 having an engaging first end 64 for engaging the teeth 57 of the ratchet wheel 56, and a second end 66 received in a holder 68. The holder 68 is connected to a supply of compressed air (not shown) to drive the pawl 62 towards the ratchet wheel 56. A spring (not shown) retracts the pawl 62 into the holder 68.

The urging devices 58, 60 are arranged so that, when each pawl 62 is driven towards the ratchet wheel 56, the pawl 62 engages one of the teeth 57 on the ratchet wheel 56, and continued driving of the pawl 62 urges the ratchet wheel 56 rotatably by a few degrees in the direction indicated by the arrow C in FIG. 6A.

In the embodiment shown, a single movement of each pawl 62 urges the ratchet wheel 56 rotatably by roughly 20° to 24°. Thus, repeated movement of the pawls 62 rotates the ratchet wheel 56 by 360°. The pawls 62 are driven alternately onto the ratchet wheel 56, so that as one pawl 62 is extended from its holder 68 to drive the ratchet wheel 56, the other pawl 62 is retracted into its holder 68.

The urging assembly 54 is operated to effect a stepwise rotation of the instrument support 15 by 20° to 24° after each pass of the cleaning device 16, i.e. after each time the cleaning device 16 has been driven down and back up the guide member 20.

The stepwise gradual rotation of the instrument support 15, and hence, the endoscope 12, after each pass means that a thorough cleaning of the endoscope 12 is effected.

The cleaning of the endoscope 12 is continued until the instrument support 15 has been rotated by 360°.

The cleaning apparatus 10 further includes a water supply arrangement 72, which comprises a water delivery member (shown in broken lines in FIG. 5) in the form of a shower head 74 and a conduit (not shown) connecting the shower head 74 to a supply of mains water.

The instrument cleaning apparatus 10 also includes an effluent discharge means 78 to discharge effluent from the instrument cleaning apparatus 10. The effluent discharge means 78 comprises a downwardly tapered lower portion 80 of the housing 11. An opening 82 in the lower portion 80 leads to a discharge conduit (not shown), which extends from the housing 11. The effluent is discharged from the instrument cleaning apparatus 10 via the discharge conduit 82, as shown by the arrow E.

The housing 11 also includes a door 84, which can be opened to allow the endoscope 12 to be mounted on the instrument support 15.

The instrument support 15 includes a plurality of mounting members 86 upon particular parts of the endoscope 12 are disposed, thereby holding the endoscope 12 on the instrument support 15 in a position that will allow the cleaning apparatus 10 to effect the most thorough cleaning of the endoscope 12.

In operation, the lid 84 is opened and the soiled endoscope 12 is mounted on the mounting members 86 on the instrument support 15. The lid 84 is then closed, and the water supply arrangement 32 connected to the supply of mains water.

The guide arrangement 18 is operated in the manner described above, and the brush 42 engages the endoscope 12. As the cleaning device 16 moves down the guide member 20, the connector 40 pivots upwardly relative to the carriage 32.

When the cleaning device 16 reaches the lower end of the guide member 20 and begins to move upwardly, the engagement of the brush 42 on the endoscope 12 pushes the cleaning device 16 so that it pivots downwardly relative to the carriage 32. This pivoting movement of the cleaning device 16 is indicated by the double headed arrow D in FIG. 2.

As the cleaning device 16 is moved down and up the guide member 20, water supplied is sprayed by the water supply arrangement 72 to wash the endoscope 12, thereby removing waste material thereon. The supply of water dispensed from the shower head 74 facilitates in washing the effluent material away through the effluent discharge means 78.

There is thus described a cleaning apparatus suitable for cleaning a surgical instrument, such as an endoscope and, in the embodiment described herein, little manual handling of the instruments is required during the cleaning process.

Various modifications can be made without departing from the scope of the invention. For example, the guide arrangement 18 may comprise a rack and pinion arrangement.

Alternatively, the guide arrangement 18 may be electrically operated with electronic control of the movement of the cleaning device 16 up and down the guide member 20. The apparatus may comprise a control device programmed to control movement of the brush 42 so that it follows the form of the endoscope 12 along its whole length. The control device may be pneumatic, hydraulic or electric.

In a further alternative, the brush 42 may be rotatably driven, for example by a motor, which may be an electric, pneumatic or hydraulic motor.

Further modifications are shown in FIGS. 7 and 8, both of which show alternative versions of the connector 40, designated 140 in FIGS. 7 and 240 in FIG. 8. FIGS. 7 and 8 are side views of the connectors 140 and 240.

Referring to FIG. 7, the connector 140 comprises a pair of first connecting members 146A, only one of which is visible in FIG. 7. The connector 140 further includes a pair of second connecting members 146B, only one of which is visible. The connector 140 also includes a pair of third connecting members 146C, only one of which is visible.

The first connecting members 146A are pivotally attached at their proximal ends to the carriage 32 by a first bracing member 150. The proximal ends of the second connecting members 146B are pivotally attached to the distal ends of the first connecting members 146A by a second bracing member 152. The proximal ends of the third connecting members 146C are pivotally attached to the distal ends of the second connecting members 146B by a third bracing member 154.

The brush 42 is rotatably mounted between the distal ends of the third connecting members 146C by the shaft 52.

Thus, the first connecting members are pivotally movable relative to the carriage 32, and the first and second connecting members 146A, 146B can articulate relative to each other. Similarly, the third connecting members 146C can articulate relative to the second connecting members 146B.

Urging means 156, which may be in the form of springs, can be provided at each of the pivotal connections between the first second and third connecting members 146A, 146B, 146C to urge the first second and third connecting members 146A, 146B, 146C to an extended condition in which the first, second and third connecting members 146A, 146B, 146C extend in a substantially straight line.

As the roller 42 moves over the endoscope 12, the pivotal attachments between the first second and third connecting members allow the first second and third connecting members 146A, 146B and 146C to articulate relative to each other, thereby allowing the roller 42 to follow the contours of the endoscope 12.

Referring to FIG. 8, the connector 240 comprises a pair of first connecting members 246A, only one of which is visible in FIG. 8. The connector 240 further includes a pair of second connecting members 246B, only one of which is visible. The connector 240 also includes a pair of third connecting members 246C, only one of which is visible.

The first connecting members 246A are pivotally attached at their proximal ends to the carriage 32 by a first bracing member 250. The second connecting members 246B are telescopically received in the first connecting members 246A, and can move slidably relative to the first connecting members 246A between retracted and extended conditions.

Similarly, the third connecting members 246C are telescopically received in the second connecting members 246B, and can move slidably relative to the second connecting members 246B between retracted and extended conditions.

The brush 42 is rotatably mounted between the distal ends of the third connecting members 246C by the shaft 52.

Urging means 254, which may be in the form of springs, are mounted within each of the first and second connecting members 246A, 246B to urge the second and third connecting members 246B and 246C to their extended conditions.

As the brush 42 moves over the endoscope 12, the second and third connecting members 246B, 246A move in and out of the first and second connecting members 246A, 246B respectively. This has the effect of allowing the brush 42 to follow the contours of the endoscope 12. The brush 42 is maintained in contact with the endoscope 12 by the urging means 254.

In yet another modification, the urging means 154, 254 could be replaced by motors, the operation of which can be computer controlled to move the first second and third connecting members 146A, 146B, 146C, 246A, 246B, 246C so that the contours of the endoscope 12 are accommodated as the roller 42 moves along the endoscope 12.

In a further modification, each of the first, second and third connecting members shown in FIG. 7 are each formed to telescoping elements.

In yet another modification, the instrument cleaning assembly 14 is arranged to rotate around the instrument support 15. One way of doing this is by fixing the instrument support 15 in position, and mounting the cleaning assembly 14 on the housing 11. Rotating means can be provided to rotate the housing 11 around the instrument support 15.

1. An instrument cleaning assembly comprising a cleaning device and a guide arrangement upon which the cleaning device is mounted, wherein the cleaning device is movable relative to the guide arrangement, and the guide arrangement guides the cleaning device to clean an instrument during the aforesaid movement, wherein the guide arrangement comprises an elongate guide member and a carriage mounted on the guide member for movement therealong, and the cleaning device comprises a brush and a connector to connect the brush to the carriage.

2. An instrument cleaning assembly according to claim 1, wherein the guide arrangement further includes a driver for driving the carriage along the guide member.

3. An instrument cleaning assembly according to claim 2, wherein the driver comprises a pneumatic or hydraulic driver, and the guide member defines an elongate chamber, and the driver comprises a piston disposed in the chamber for movement therealong.

4. An instrument cleaning assembly according to claim 3, wherein the carriage is attached to the piston, and the chamber has an elongate opening which extends substantially the length of the chamber, the guide member having fluid connection means to connect the chamber in fluid communication with a supply of pneumatic or hydraulic fluid, and wherein sealing means is provided along the opening to prevent leakage of fluid therefrom, the sealing means comprising an elongate sealing member extending along the opening.

5. (canceled)

6. An instrument cleaning assembly according to claim 4, wherein the sealing means comprises inner and outer elongate sealing members extending along the opening.

7. An instrument cleaning assembly according to claim 2, wherein the driver comprises a mechanical driver, and the guide arrangement comprises a rack and pinion arrangement, the driver being operable to rotate the pinion to move the carriage along the rack.

8. An instrument cleaning assembly according to claim 2, wherein the driver is an electric driver, comprising an electric motor.

9. (canceled)

10. (canceled)

11. An instrument cleaning assembly according to claim 1, wherein the brush is rotatably mounted on the connector, and the connector is pivotally mounted on the carriage for pivotal movement relative thereto.

12. An instrument cleaning assembly according to claim 11, wherein the connector comprises first and second connecting members arranged opposite each other, the brush extending from the first connecting member to the second connecting member, and the connector further includes a bracing member, which extends from the first to the second connecting member.

13. (canceled)

14. An instrument cleaning assembly according to claim 1, wherein the connector has a proximal end region and a distal end region, the brush being mounted on the connector at the distal end region, and the proximal end region of the connector being pivotally mounted on the carriage.

15. An instrument cleaning apparatus comprising an instrument cleaning zone in which an instrument to be cleaned can be disposed, and at least one instrument cleaning assembly as claimed in claim 1 disposed adjacent to the instrument cleaning zone.

16. An instrument cleaning apparatus according to claim 15, comprising an instrument support provided at the instrument cleaning zone, the instrument support being elongate, and having a longitudinal axis, the instrument support being rotatable about the longitudinal axis, thereby rotating the instrument relative to the cleaning assembly.

17. (canceled)

18. (canceled)

19. An instrument cleaning apparatus according to claim 16, comprising an urging assembly to urge the support rotatably about the longitudinal axis.

20. An instrument cleaning apparatus according to claim 19, wherein the urging assembly comprises a rotor on the instrument support, and an urging device to engage the rotor and urge the rotor rotatably, thereby rotating the instrument support.

21. An instrument cleaning apparatus according to claim 20, wherein the rotor comprises a ratchet member, and the urging device comprises a pawl engageable with the ratchet member to impart said rotary motion thereto.

22. An instrument cleaning apparatus according to claim 21, wherein the urging device is pneumatically or hydraulically operated, and includes a chamber in which the pawl is reciprocally mounted, the chamber receiving said pneumatic or hydraulic fluid to move said pawl into engagement with said ratchet member.

23. An instrument cleaning apparatus according to claim 19, wherein the urging assembly comprises a plurality of holding members to hold the instrument on the support.

24. An instrument cleaning apparatus according to claim 15, comprising a water supply arrangement for supplying water to the, or each, instrument cleaning assembly, wherein the water supply arrangement comprises a water dispenser and a conduit for connection to a supply of water.

25. (canceled)

26. An instrument cleaning apparatus according to claim 24, wherein the water dispenser comprises a shower head for spraying water onto the, or each, instrument cleaning assembly, and wherein the water supply arrangement comprises drive means to rotate the water dispenser and a discharge means to discharge effluent from the instrument cleaning apparatus.

27. (canceled)

28. An instrument cleaning apparatus according to claim 16, comprising a housing within which the instrument support is housed, and the, or each, instrument cleaning assembly being provided within the housing, wherein the housing comprises a lid to allow the instrument to be disposed in the instrument receiving zone.

29. (canceled)
